(19) United States
(12) Patent Application Publication
(10) Pub. No.: US 2025/0187980 A1
(43) Pub. Date: Jun. 12, 2025

(54) CONCRETE HAVING A LOW CEMENT CONTENT

(71) Applicant: VINCI CONSTRUCTION FRANCE, Nanterre Cedex (FR)

(72) Inventors: François CUSSIGH, MEZY SUR SEINE (FR); Paul-Alexandre FRANCO, CORBEIL-ESSONNES (FR); Julien SEMENADISSE, MALAKOFF (FR)

(21) Appl. No.: 18/717,787

(22) PCT Filed: Dec. 8, 2022
(86) PCT No.: PCT/EP2022/085069

§ 371 Date: Jun. 7, 2024

(30) Foreign Application Priority Data
Dec. 10, 2021 (FR) FR2113317

(51) Int. Cl. C04B 28/04; C04B 14/28; C04B 28/08; C04B 103/32; C04B 111/60

(52) U.S. Cl. CPC C04B 28/04; C04B 14/28; C04B 28/08; C04B 2103/32; C04B 2111/60; C04B 2201/50

(57) ABSTRACT

The present invention relates to a fresh concrete composition comprising at least: i) a hydraulic binder comprising:—from 20% to 40% by weight of Portland cement clinker based on the total weight of said binder, —from 45% to 75% by weight of filler based on the total weight of said binder, and—from 5% to 15% by weight of material of ultrafine particle size based on the total weight of said binder, selected from hydraulic additives, pozzolanic additives, ultrafine cements and mixtures thereof, ii) at least one superplasticiser or plasticiser, iii) water, and iv) aggregates.

### TECHNICAL FIELD

The present invention relates to a structural concrete formulated from a binder with a low clinker content and a high filler content, in particular having a fluid consistency in the fresh state. The invention also relates to a method for manufacturing such a concrete.

### PRIOR ART

The use of cement concrete, conventionally considered as structural concrete, is a matter of concern in terms of environmental impact. More specifically, this concrete requires the use of a Portland cement-based binder to agglomerate a mixture of aggregates and sand. However, the manufacture of clinker, an essential constituent of Portland cement, contributes significantly to CO₂ emissions.

With the aim of reducing CO₂ emissions linked to the manufacture of concrete, it has been proposed to partially replace the clinker with one or more replacement materials such as blast furnace slag, fly ash, silica fume, metakaolin, or limestone or siliceous fillers. However, if a significant portion of the clinker content is replaced, this generally has a negative impact on the properties of a structural concrete, in particular its mechanical strength and its durability. The reactivity of these replacement materials therefore usually determines their degree of replacement in structural concrete to maintain the required level of quality. For example, blast furnace slag, which is a latent hydraulic binder, allows to a high degree of replacement, of up to more than 80%. However, there are limited resources of slag, which is already used in concrete. As for fly ash, this has a pozzolanic effect which allows replacement of the clinker by up to around 50%. Here again, resources are limited and will eventually peter out owing to the harmful environmental impact of thermal power plants. Regarding the ultrafine additives used in concrete, such as silica fume or metakaolin, they are usually incorporated in small amounts, for example of from 5% to 20% by mass of binder, due to their cost and because they require more water than cement. As for the other usual additives such as limestone or siliceous fillers, these are quasi-inert and therefore do not allow a significant reduction in the clinker content.

The report “Eco-efficient cements: Potential, economically viable solutions for a low-CO₂, cement-based materials industry”, published by UNEP (the United Nations Environment Programme) in 2016, proposes the use of calcined clays, notably metakaolin, combined with limestone filler to replace up to 50% of the clinker. Thus, Antoni et al. [1] proposes mortar formulations in which the cement is partially replaced by a mixture of metakaolin and limestone filler in a metakaolin: limestone filler weight ratio of 2:1 and in a water/binder ratio of 0.5. However, the proportion of ultrafines in these compositions is high, involving a high cost and a high requirement in terms of water.

Lastly, concrete compositions with a low cement content, using a very low amount of water, have also been proposed in WO 2007/132098. However, the fresh concretes obtained from such compositions do not have the fluidity and in particular the viscosity required to be able to be used on construction sites.

There is therefore a need for a concrete with a low clinker content that does not have the disadvantages of the prior art.

In particular, there is a need for a concrete with a low clinker content having, on the one hand, a fluid consistency and a low viscosity in the fresh state, allowing its use on construction sites, in particular during transport and/or installation, and on the other hand a mechanical strength allowing it to be used as structural concrete.

There is also a need for a low-cost concrete with a low clinker content.

The aim of the invention is precisely to provide a concrete having a low clinker content and a high filler content which is satisfactory in these terms. In particular, it aims to propose a new concrete composition having a low clinker content making it possible to effectively improve the compromise between the workability, associated with high fluidity and low viscosity, of the concrete in the fresh state, and on the other hand the mechanical strength of the concrete in the hardened state.

Against all expectations, the inventors have found that these objectives can be achieved via a composition in accordance with the invention.

### DISCLOSURE OF THE INVENTION

The present invention therefore relates, according to a first aspect, to a fresh concrete composition comprising at least:
i) from 350 kg/m³ to 550 kg/m³ of hydraulic binder, referred to as binder, comprising:
   from 20% to 40% by weight of Portland clinker relative to the total weight of said binder, the particles of which have a D₅₀ of greater than 11 μm and a Blaine specific surface area of less than or equal to 5500 cm²/g,
   from 45% to 75% by weight of filler relative to the total weight of said binder, the particles of which have a Do of less than or equal to 63 μm, and
   from 5% to 15% by weight of an ultrafine particle size material relative to the total weight of said binder, the particles of which have a BET specific surface area of greater than or equal to 5 m²/g or a D₅₀ of less than or equal to 8 μm, and selected from hydraulic additives, pozzolanic additives, ultrafine cements and mixtures thereof,
ii) at least 0.05% by weight, expressed as dry extract relative to the total weight of said binder, of superplasticizer or plasticizer,
iii) water in a water/binder mass ratio ranging from 0.3 to 0.45, and
iv) aggregates.

“Fresh concrete” means concrete as obtained after mixing the various constituents thereof and before it sets, that is to say concrete which has the capacity to deform and/or to flow.

The inventors have thus developed an original fresh concrete composition for the production of concrete with a low clinker content. This composition is advantageous in several respects. As is clear from the examples below, it makes it possible to obtain a good compromise between mechanical strength on the one hand, and the fluidity and viscosity of the concrete in the fresh state on the other hand. Furthermore, it makes it possible to obtain a concrete the CO₂ emissions of which are greatly reduced compared to traditional concrete owing to the low clinker content, and the reduction of water in the concrete formulation makes it possible to go further as regards the environmental optimization of the composition. Lastly, such a concrete can advantageously be used as structural concrete, and can reach grades of strength of at least class C25/30, or even class C30/37. In particular, the selection of the components of the ternary mixture forming the binder and the proportions thereof makes it possible, by adjusting the water/binder ratio and the superplasticizer(s) or plasticizer(s), to obtain a fresh concrete composition in which the paste, separating out the aggregates, has a volume and viscosity adapted to achieve a fluid consistency as required for use on a construction site, while promoting reactivity of the binder and granular stacking allowing excellent mechanical strength properties to be achieved after setting and at 28 days.

The invention also relates to the use of a hydraulic binder, in particular as described in the present invention, comprising:
from 20% to 40% by weight of Portland clinker relative to the total weight of said binder, the particles of which have a D₅₀ of greater than 11 μm and a Blaine specific surface area of less than or equal to 5500 cm²/g,
from 45% to 75% by weight of filler relative to the total weight of said binder, the particles of which have a D₇₀ of less than or equal to 63 μm, and
from 5% to 15% by weight of an ultrafine particle size material relative to the total weight of said binder, the particles of which have a BET specific surface area of greater than or equal to 5 m²/g or a D₅₀ of less than or equal to 8 μμm, and selected from hydraulic additives, pozzolanic additives, ultrafine cements and mixtures thereof,

and the clinker/filler weight ratio of which is at least 0.32,

so as to form a fresh concrete having an Abrams cone slump of greater than or equal to 160 mm, preferably greater than or equal to 180 mm, measured according to standard NF EN 12350-2 at a temperature of 20°° C. after mixing, and a viscosity of less than or equal to 9 seconds, preferably less than or equal to 6 seconds, measured by the inverted cone method according to standard XP P18-469 at a temperature of 20° C. after mixing.

The hydraulic binder is particularly advantageous for forming a fresh concrete with a fluid consistency and a low viscosity, corresponding to the properties required for pouring the concrete on a construction site or as prefabricated elements.

The invention also relates to the use of a fresh concrete composition, in particular according to the invention, comprising at least:
i) a hydraulic binder comprising:
   from 20% to 40% by weight of Portland clinker relative to the total weight of said binder, the particles of which have a D₅₀ of greater than 11 μm and a Blaine specific surface area of less than or equal to 5500 cm²/g,
   from 45% to 75% by weight of filler relative to the total weight of said binder, the particles of which have a Do of less than or equal to 63 μm, and
   from 5% to 15% by weight of an ultrafine particle size material relative to the total weight of said binder, the particles of which have a BET specific surface area of greater than or equal to 5 m²/g or a D₅₀ of less than or equal to 8 μm, and selected from hydraulic additives, pozzolanic additives, ultrafine cements and mixtures thereof,
ii) at least a superplasticizer or plasticizer,
iii) water, and
iv) aggregates,

and the Abrams cone slump of which is greater than or equal to 160 mm, measured according to standard NF EN 12350-2 at a temperature of 20°° C. after mixing, and the viscosity of which is less than or equal to 9 seconds, measured by the inverted cone method according to standard XP P18-469 at a temperature of 20°° C. after mixing,

so as to form a hardened concrete having a compressive strength of greater than or equal to 25 MPa, preferably greater than or equal to 30 MPa, measured on cylinders according to standard NF EN 12390-3, 28 days after placing said binder in contact with water.

In addition to having the properties of a fluid consistency and a low viscosity required in the fluid state for use on a construction site or for the preparation of prefabricated elements, the fresh concrete composition makes it possible to form a hardened concrete having the mechanical properties required for structural concrete.

The invention relates to a method for preparing a hardened concrete comprising the use of a hydraulic binder comprising:
from 20% to 40% by weight of Portland clinker relative to the total weight of said binder, the particles of which have a D₅₀ of greater than 11 μm and a Blaine specific surface area of less than or equal to 5500 cm²/g,
from 45% to 75% by weight of filler relative to the total weight of said binder, the particles of which have a Do of less than or equal to 63 μm, and
from 5% to 15% by weight of an ultrafine particle size material relative to the total weight of said binder, the particles of which have a BET specific surface area of greater than or equal to 5 m²/g or a D₅₀ of less than or equal to 8 μm, and selected from hydraulic additives, pozzolanic additives, ultrafine cements and mixtures thereof,

and the clinker/filler weight ratio of which is at least 0.32.

The binder may be used in the form of a fresh concrete composition according to the invention. In particular, the method uses a fresh concrete composition having the flow properties described above, and makes it possible to obtain a structural concrete.

The method for preparing a hardened concrete may advantageously be implemented on a construction site.

The uses and the method according to the invention are particularly advantageous for forming a structural element such as a pile, a diaphragm wall, a footing, a ground beam, a slab, a floor, a post, a beam or a shell.

Lastly, the invention relates to a hardened concrete obtained from the fresh concrete composition according to the invention or obtained using the method according to the invention.

The adjective “dry” describes a material which does not contain any water.

In the remainder of the text, the weight ratios are expressed as dry extract.

Within the meaning of the invention, the expression “compound content”, for example “filler content”, covers the use of a single filler or a mixture of several fillers.

### DETAILED DESCRIPTION

### i) Hydraulic binder

The fresh concrete composition comprises from 350 kg/m³ to 550 kg/m³ of hydraulic binder. The quantity of hydraulic binder varies depending on the type of concrete in question and adjustment thereof clearly falls within the competence of those skilled in the art.

For example, for a self-consolidating concrete, the hydraulic binder content is higher than for a conventional concrete and in particular of the order of 450 kg/m³ to 550 kg/m³.

According to another embodiment, the fresh concrete composition may comprise from 350 kg/m³ to 450 kg/m³ of hydraulic binder.

In the remainder of the text, the hydraulic binder is also referred to as the binder.

### A) Portland Clinker

Portland clinker, also referred to as clinker in this description, may be used in the form of an isolated Portland clinker and/or in the form of a Portland cement. Preferably, the clinker is used in the form of a Portland cement, in particular selected from the cements defined in European standard NF EN 197-1, in particular of type CEM I, CEM II, CEM III, CEM IV or CEM V.

Preferably, the clinker is used in the form of a Portland cement selected from CEM I and CEM II/A.

A CEM I comprises at least 95% clinker. A CEM II/A comprises at least 80% clinker. For example, the CEM I and the CEM II/A may further comprise a material selected from slag, silica fume, pozzolans, fly ash, calcined shale, limestone and mixtures thereof. The CEM II may be a CEM II/A-S, a CEM II/A-D, a CEM II/A-P, a CEM II/A-Q, a CEM II/A-V, a CEM II/A-W, a CEM II/A-T, a CEM II/A-L, a CEM II/A-LL, or a CEM II/A-M.

In particular, the clinker is used in the form of a Portland cement selected from CEM I, CEM II/A-L, CEM II/A-LL and mixtures thereof, preferably in the form of a CEM I, in particular a CEM I 52.5 N.

For example, the binder may comprise from 20% to 40% by weight of CEM I relative to the total weight of said binder.

The clinker particles have a D₅₀ of greater than 11 μm, preferably greater than or equal to 12 μm, more preferably ranging from 12 μm to 25 μm, in particular from 12 μm to 20 μm.

In particular, the clinker particles have a D₉₀ of greater than or equal to 30 μm.

In particular, the clinker particles have a D₉₇ of greater than 35 μm.

The percentiles or “centiles” 50 (D₅₀), 70 (D₇₀), 87 (D₈₇), 90 (D₉₀) and 97 (D₉₇) of a powder are the particle sizes corresponding to the percentages, by mass, of 50%, 70%, 87%, 90% and 97% respectively, on the cumulative particle size distribution curve of the powder particle sizes, the particle sizes being classified in ascending order. For example, 70% by mass of the particles in a powder have a size less than D₇₀ and 30% by mass of the particles have a size greater than D₇₀. The sizes and percentiles may be determined on the basis of a particle size distribution performed using a laser diffraction particle size analyzer, in particular using the liquid dispersion method. For example, it may be a particle size analyzer known as “MASTERSIZER 3000” from the company Malvern. The percentile 50 D₅₀ is also conventionally referred to as the “median diameter”.

The clinker particles have a Blaine specific surface area of less than or equal to 5500 cm²/g, in particular less than or equal to 5200 cm²/g, and more particularly ranging from 3000 cm²/g to 5200 cm²/g. The Blaine specific surface area is measured according to standard NF EN 196-6.

Thus, the clinker is advantageously used in the form of a cement other than an excessively ground cement.

The hydraulic binder comprises from 20% to 40% by weight of clinker relative to the total weight of said binder. The binder may comprise at least 23% by weight, preferably from 25% to 40% by weight, and more preferably from 25% to 35% by weight of clinker relative to the total weight of said binder.

The fresh concrete composition may comprise from 70 kg/m³ to 220 kg/m³ of clinker, preferably from 75 kg/m³ to 150 kg/m³ of clinker.

### B) Filler

The filler particles have a D₇₀ of less than or equal to 63 μm.

The filler may be selected from the fillers defined in standard NF EN 12620.

In particular, the filler is selected from quasi-inert fillers and mixtures thereof. Quasi-inert filler means a type I mineral additive according to standard NF EN 206/CN. In particular, a quasi-inert filler is different from a hydraulic or pozzolanic additive. A filler is said to be quasi-inert as it not predisposed to react with water or cement.

Those skilled in the art know how to select a quasi-inert filler from among the usual constituents of a binder used for forming concrete.

The filler may be selected from limestone fillers such as calcium carbonate, siliceous fillers such as quartz, silico-limestone fillers, and mixtures thereof, in particular from limestone fillers, siliceous fillers and mixtures thereof.

Preferably, the filler comprises at least one limestone filler, and more preferably the filler is a limestone filler.

Limestone fillers may, for example, be limestone additives as defined in standard NF P 18-508.

Limestone fillers are particularly advantageous thanks to their low environmental impact and ready availability.

The filler may be characterized by a Blaine specific surface area ranging from 2000 cm²/g to 9000 cm²/g, preferably from 3500 cm²/g to 7000 cm²/g.

The binder comprises from 45% to 75% by weight of filler relative to the total weight of said binder. The binder may comprise from 45% to 70% by weight, preferably from 45% to less than 65% by weight, in particular from 50% to 58% and more particularly from 50% to 55% by weight of filler relative to the total weight of said binder.

In the case of a clinker used in the form of Portland cement itself incorporating a filler as described above, the quantity of filler thus introduced with the cement is taken into account for the evaluation of the filler content in the binder. This is particularly the case for a CEM II/A-L.

The fresh concrete composition may include from 160 kg/m³ to 400 kg/m³ of filler, preferably from 200 kg/m³ to 300 kg/m³ of filler.

### C) Ultrafine Particle Size Material

The ultrafine particle size material is advantageously a reactive mineral powder in a cementitious medium. More specifically, it is selected from hydraulic additives, pozzolanic additives, ultrafine cements and mixtures thereof. For example, the hydraulic and pozzolanic additives are type II additives according to standard NF EN 206/CN.

By definition, a hydraulic additive is a mineral additive that reacts with water. It may for example be ground slag.

A pozzolanic additive is a mineral additive that reacts with calcium hydroxide in the presence of water. It may be, for example, silica fume, metakaolin, calcined clays, fly ash, natural pozzolans.

An ultrafine cement is most particularly a cement of class CEM I, CEM II, CEM III, CEM IV or CEM V according to European standard NF EN 197-1 or the like, the grinding of which is finer than that of common cements of the same classes.

The ultrafine particle size material may be selected from slag, silica fume, metakaolin, calcined clays, fly ash, natural or artificial pozzolanic additives, ultrafine cements of class CEM I, CEM II, CEM III, CEM IV or CEM V, and mixtures thereof, in particular from blast furnace slag, silica fume, metakaolin, calcined clays, natural or artificial pozzolanic additives, ultrafine cements of class CEM I, CEM II, CEM III, CEM IV or CEM V and mixtures thereof.

Metakaolin is usually obtained by calcination of clay composed mainly of kaolinite at temperatures ranging from 600°° C. to 900°° C. For example, the metakaolin may be selected from metakaolins complying with standard NF P 18-513.

Silica fume is usually a by-product of metallurgy and the production of silicon or ferrosilicon. Silica fume is generally formed of spherical particles comprising at least 85% by mass of amorphous silica. The silica fume may be selected from silica fumes complying with standard NF EN 13263-1.

The fly ash may be selected from fly ash complying with European standard NF EN 450-1.

Conventionally, the slag is ground granulated blast-furnace slag (GGBS).

GGBS is a granular material generally obtained by rapid cooling with water of molten slag from the smelting of iron ore in a blast furnace, followed by grinding to improve the reactivity of the GGBS. GGBS is an amorphous alumino-silicate glass, essentially composed of SiO₂, CaO, MgO, and Al₂O₃. GGBS is preferably manufactured according to European standard NF EN 15167-1.

The ultrafine cements used as ultrafine particle size material may be excessively ground cements. As an example of cements that may be used as an ultrafine particle size material, mention may be made of cements from the Spinor® range sold by the company EQIOM, in particular the materials sold under the names “Spinor® A6”, “Spinor® A12” and “Spinor® A32”.

The ultrafine particle size material may also be a filler made from coproducts resulting, among other things, from the production of stainless steel. For example, it may be the product sold under the name Fillinox® by the company Orbix.

The particles of the ultrafine particle size material may have a D₅₀ of less than or equal to 8 μm, in particular ranging from 1 to 8 μm.

The particles of the ultrafine particle size material may have a D₉₀ of less than or equal to 30 μm, preferably ranging from 4 μm to 30 μm, in particular from 10 μm to 30 μm. In particular, the particles of the ultrafine particle size material have a D₉₀ of greater than 1 μm, or even greater than or equal to 3 μm.

The ultrafine particle size material may have a specific surface area obtained by the BET (Brunauer-Emmet-Teller) method of greater than or equal to 5 m²/g, preferably ranging from 5 m²/g to 35 m²/g, notably from 10 m²/g to 25 m²/g.

The ultrafine particle size material may be characterized by a Blaine specific surface area of greater than or equal to 5500 cm²/g, preferably ranging from 6500 cm²/g to 12 000 cm²/g, notably from 7000 cm²/g to 10 000 cm²/g.

The hydraulic binder comprises from 5% to 15% by weight of ultrafine particle size material relative to the total weight of said binder. The hydraulic binder generally comprises at least 7% by weight, in particular from 7.5% to 14% by weight or even from 11% to 14% by weight of ultrafine particle size material relative to the total weight of said binder.

In the case of a clinker used in the form of a Portland cement comprising an ultrafine particle size material, the quantity of this ultrafine particle size material introduced with the cement is taken into account in the evaluation of the ultrafine particle size material content in the binder. For example, in the case of a CEM II/A-D, the quantity of silica fume present in the cement is taken into account in the calculation of the ultrafine particle size material content of the fresh concrete composition, provided that the particle size distribution actually corresponds to that required according to the invention for the ultrafine particle size material.

The fresh concrete composition may comprise from 20 kg/m³ to 80 kg/m³ of ultrafine particle size material, preferably from 30 kg/m³ to 60 kg/m³.

The clinker, the filler and the ultrafine particle size material may form at least 80% by weight, preferably at least 90% by weight, more preferably at least 95% by weight, or even more than 99% of the total weight of said binder. The binder may also consist of only clinker, filler and ultrafine particle size material.

Preferably, the clinker and the filler are used in a clinker/filler weight ratio of at least 0.32, preferably greater than or equal to 0.4. The clinker/filler weight ratio is generally less than or equal to 1.8, preferably less than or equal to 1.0 and more preferably less than or equal to 0.7. According to a preferred embodiment, it ranges from 0.4 to 0.7. These weight ratios are particularly advantageous for obtaining high-performance mechanical properties of the hardened concrete, while guaranteeing a fluid consistency of this concrete in the fresh state. At values below, it is found that the high-performance mechanical properties of the hardened concrete may certainly be maintained but to the detriment of the fluid, low-viscosity consistency of the fresh concrete and therefore of its workability.

### ii) Superplasticizer or Plasticizer

The fresh concrete composition may comprise a superplasticizer or plasticizer selected from NBSP (naphthalene-based superplasticizers), PNS (polynaphthalene sulfonates), MBSP (melamine-based superplasticizers), PMS (polymelamine sulfonates), HCA (hydroxycarboxylic acids), (P) AA (poly (acrylic acid)), LS (lignosulfonates), in particular ammonium, calcium or sodium lignosulfonates, PCE (polycarboxylic ethers), PCA (polycarboxylic acids), phosphonates, their salts and/or their derivatives and mixtures thereof.

In particular, the superplasticizer(s) or plasticizer(s) are selected from PCE (polycarboxylic ethers), PCA (polycarboxylic acids), phosphonates, NBSP (naphthalene-based superplasticizers), PNS (polynaphthalene sulfonates), LS (lignosulfonates) and mixtures thereof, preferably selected from PCE (polycarboxylic ethers), PCA (polycarboxylic acids), phosphonates and mixtures thereof.

The composition comprises at least 0.05% by weight, expressed as dry extract relative to the total weight of said binder, of superplasticizer or plasticizer. In particular, the composition may comprise from 0.05% to 1% by weight, preferably from 0.1% to 0.5% by weight, expressed as dry extract relative to the total weight of said binder, of superplasticizer or plasticizer.

In particular, the superplasticizer(s) or plasticizer(s) is/are used in the fresh concrete composition at a rate of from 0.2 kg/m³ to 5 kg/m³, preferably from 0.5 kg/m³ to 2 kg/m³, expressed as dry extract.

The use of at least one superplasticizer or plasticizer is advantageous in several respects. This compound advantageously makes it possible to deflocculate the particles of the binder, and in particular to deflocculate the particles of the ultrafine particle size material. It is thus possible, on the one hand, to obtain a fluidity adapted to its use on a construction site for a low water content of the concrete, and on the other hand to increase the reactivity of the particles of ultrafine particle size and therefore the compressive strength of the concrete.

iii) Water

Water is used in the fresh concrete composition in a water/binder mass ratio ranging from 0.3 to 0.45.

The water is made up of all the water present in the fresh concrete composition, that is to say the mixing water, and the water added to the composition with the superplasticizer or any adjuvants.

Preferably, the fresh concrete composition uses water in a water/binder mass ratio ranging from 0.3 to 0.4, preferably greater than 0.32, more preferably at least 0.34, or even ranging from 0.36 to 0.4.

The fresh concrete composition may comprise from 130 kg/m³ to 200 kg/m³ of water, preferably more than 140 kg/m³, and more preferably more than 150 kg/m³ of water.

The water/binder ratio according to the invention differs in particular from that usually used to characterize cements or binders, in which the quantity of water is usually equal to half the dosage of binder.

### iv) Aggregates

The term “aggregate” refers to a broad category of particulate materials used in construction. For the purposes of the invention, the term “aggregate” excludes fillers as defined above.

The aggregates may be selected from sand, fine sand, gravel, fine gravel, pebbles, crushed rock, slag, crushed or recycled concrete, geosynthetic aggregates, expanded shale, expanded clay and mixtures thereof. For example, the crushed rock may be made up of siliceous, limestone, and/or silico-limestone rocks. Preferably, the aggregates comprise at least sand, fine gravel or mixtures thereof.

For example, the aggregates are selected from materials complying with article 10 of standard NF P 18-545.

Preferably, the aggregates have a size less than 32 mm. Preferably, the aggregates comprise at least one material with a particle size of between 6 mm and 32 mm.

The size of the aggregates, or particle size, corresponds to the diameter of the smallest sphere circumscribed by the particle. It may be measured by sieving.

Most often, the aggregates used on a construction site are in wet form given that they are usually handled in an outdoor environment. The water/binder ratios take into account the water resulting from the moisture in the aggregates.

The aggregates may be present in a weight proportion ranging from 55% to 85% relative to the total weight of the fresh concrete, or in a volume proportion ranging from 55% to 70% relative to the total volume of the fresh concrete. In particular, the aggregates are used in the fresh concrete composition at a rate of 1300 kg/m³ to 2000 kg/m³, preferably from 1500 kg/m³ to 1800 kg/m³.

### Fresh Concrete Composition

All the aggregates of a size greater than or equal to 63 μm form a granular skeleton.

The mixture of the binder, water, superplasticizer(s) or plasticizer(s) and, where applicable, entrapped air and sand particles with a diameter of less than 63 μm, forms a paste. The paste advantageously makes it possible to separate the particles from the granular skeleton and move them apart from one another.

Preferably, the volume of said paste is greater than or equal to 115%, in particular 120%, or even between 120% and 135%, of the porous volume of the granular skeleton, also referred to as the void volume of the granular skeleton.

The porous volume of the granular skeleton, also referred to as the void volume of the granular skeleton, may be measured on the basis of the compactness of the granular skeleton obtained after vibration of all the particles of the granular skeleton. It may also be established according to the compressible packing model [2] on the basis of the measurement of compactness of each category of particles making up the granular skeleton.

An excess volume of paste relative to the porous volume of the granular skeleton ensures good spacing between the particles of the granular skeleton, helping the fresh concrete to flow. In addition, the water/binder ratio required in the fresh concrete makes it possible to limit the viscosity of the paste. The combination of an excess volume of paste with the required water/binder ratio is advantageously beneficial for ensuring that the fresh concrete composition has a viscosity suitable for its use on a construction site or in a prefabrication plant, and in particular for ensuring a fluid consistency.

The fresh concrete composition may also include one or more adjuvant(s) selected from water retainers, thickeners, antifoams, biocides, pigments, flame retardants, air entrainers, retarders, accelerators, fibers, dispersion powders, wetting agents, polymer resins, complexing agents, polymer dispersions, shrinkage reducing agents, and mixtures thereof.

In particular, the fresh concrete composition has a viscosity of less than or equal to 9 seconds, preferably less than or equal to 6 seconds, or even less than 6 seconds, measured by the inverted cone method according to standard XP P 18-469 at a temperature of 20° C. after mixing, that is to say after obtaining a homogeneous mixture of all of its components.

It may have an Abrams cone slump of greater than or equal to 160 mm, preferably greater than or equal to 180 mm, measured according to standard NF EN 12350-2 at a temperature of 20° C. after mixing.

The fresh concrete composition advantageously makes it possible to obtain a concrete that is at least as fluid as a concrete falling within consistency class S4 according to standard NF EN 206/CN. In particular, the fresh concrete composition may have the consistency required for self-consolidating concrete. In particular, it makes it possible to obtain a concrete falling within consistency class S5 according to standard NF EN 206/CN.

### Method for Preparing Hardened Concrete

A hardened concrete may be prepared by a method comprising the use of a hydraulic binder as described above.

The method according to the invention may comprise at least the steps consisting in:
a) forming said fresh concrete composition by mixing the components thereof;
b) where appropriate, pouring the fresh concrete composition, and
c) allowing said fresh concrete composition to harden so as to obtain said hardened concrete.

The various mixing techniques known to those skilled in the art may be used. For example, the fresh concrete composition may be formed by successive addition of the components while mixing, mixing being continued until the fresh concrete is obtained. Mixing may be carried out in a conventional mixer, in particular a forced action mixer. Those skilled in the art will know how to adjust the duration or power of mixing in order to obtain a homogeneous fresh concrete composition.

The fresh concrete composition may be poured according to the usual methods known to those skilled in the art.

After hardening of the fresh concrete composition, in particular by hydration and/or hardening, a hardened concrete such as a structural element is obtained. In particular, the hardened concrete obtained may be in the form of a pile, a diaphragm wall, a footing, a ground beam, a slab, a floor, a post, a beam or a shell.

### Hardened Concrete

A hardened concrete may be obtained from the fresh concrete composition described above, or using the method as described above.

The hardened concrete according to the invention is advantageously a concrete having a mechanical strength at least as high as a concrete falling within strength class C25/30. In particular, the hardened concrete is a concrete falling within strength class C25/30 or C30/37, and more particularly strength class C25/30.

The hardened concrete may have a compressive strength of greater than or equal to 3 MPa, preferably greater than or equal to 5 MPa, measured according to standard NF EN 12390-3, 24 hours after placing the binder in contact with water and storage at a temperature of 20° C. Preferably, the hardened concrete has a compressive strength of greater than or equal to 25 MPa, preferably greater than or equal to 30 MPa, measured on cylinders according to standard NF EN 12390-3, 28 days after placing said binder in contact with water.

Such a hardened concrete is particularly useful for forming structural elements. Preferably, the hardened concrete is in the form of a pile, a diaphragm wall, a footing, a ground beam, a slab, a floor, a post, a beam or a shell.

The hardened concrete may be in the form of a structural element, in particular a prefabricated or cast element, in particular a structural element of a building or public works such as in an infrastructure or superstructure.

### EXAMPLE

### Material and Methods

The following raw materials were used:
Le Havre CEM I 52.5 N cement supplied by the company Vracs de l'Estuaire having a Blaine specific surface area of 4700 cm²/g and a median diameter D₅₀ of 12 μm;
Betocarb HP EN limestone filler supplied by the company Omya having a D₈₇ of 63 μm;
superplasticizer sold by the company Chryso under the name Optima 175;
Pécy 0/4 limestone sand supplied by the company A2C;
Pécy 4/20 limestone fine gravel supplied by the company A2C;
Ultrafine particle size materials:

Moerdijk ultrafine slag sold by the company Ecocem having a median diameter D₅₀ of 2.25 μm;

Les Clavaux DP silica fume sold by the company Ferropem having a BET specific surface area of 21.5 m²/g;

Fumel Argicem metakaolin sold by the company Argeco having a BET specific surface area of 17.5 m²/g;

Spinor A32 CEM III sold by the company Eqiom having a median diameter D₅₀ of 6 μm.

### Measurements on Concrete Equivalent Mortars

It is known that the physical characteristics of concrete equivalent mortars are representative of the physical characteristics of the corresponding concretes.

Viscosity was measured for concrete equivalent mortars by determining the flow time in a mini “V” funnel at a temperature of 20°° C. according to the methodology of standard NF EN 12350-9.

Spread measurements were carried out on concrete equivalent mortar at a temperature of 20° C. according to the provisions of standard NF EN 12350-8 using the CEM mini-cone (1/2 scale Abrams cone).

Compressive strength was measured for concrete equivalent mortars on 4 cm×4 cm×16 cm prisms according to standard NF EN 196-1, at 24 hours and 28 days.

### Measurements on Concrete

The volume of the granular skeleton was established according to the compressible packing model [2]. Viscosity was measured after mixing for fresh concrete compositions by determining the flow time in a “V” funnel at a temperature of 20° C. according to the provisions of standard XP P18-469.

Abrams cone slump measurements were carried out after mixing, on fresh concrete compositions at a temperature of 20°° C. according to the provisions of standard NF EN 12350-2.

Compressive strength was measured for hardened concrete on cylindrical specimens with a diameter of 110 mm and a height of 220 mm according to standard NF EN 12390-3, at 18 hours, 24 hours, 7 days and 28 days.

### Example 1

### Preparation Of Concrete Equivalent Mortars According to and not According to the Invention for Various Cement Contents

The binder was prepared by dry mixing of cement (CEM), limestone filler (FC) and metakaolin (MK) in the proportions indicated in table 1.

The concrete equivalent mortar was prepared by mixing the sand, the binder, the superplasticizer and water, the water/binder weight ratio (W/B) and the superplasticizer content, expressed in commercial weight, being given in table 1.

The binders used in tests A and B comprised 35% and 12.5% cement, respectively.

TABLE 1

| | | Test A | Control B |
|---|---|---|---|
| Binder | CEM (kg/m³) | 140 | 50 |
| | MK (kg/m³) | 50 | 50 |
| | FC (kg/m³) | 210 | 300 |

| | | |
|---|---|---|
| 0/4 sand (kg/m³) | 1038 | 1038 |
| Superplasticizer (kg/m³) | 5.8 | 5.9 |
| W/B | 0.4 | 0.4 |

### Example 2

### Preparation of Concrete Equivalent Mortars According to and not According to the Invention for Various Metakaolin Contents

Concrete equivalent mortars were prepared according to the protocol described in example 1, in the proportions given in table 2.

The binders used in tests A, C, D, E and F comprised 12.5%, 0%, 5%, 10% and 15% metakaolin, respectively.

TABLE 2

| | | Test | Control | Test | Test | Test |
|---|---|---|---|---|---|---|
| | | A | C | D | E | F |
| Binder | CEM (kg/m³) | 140 | 140 | 140 | 140 | 140 |
| | MK (kg/m³) | 50 | 0 | 20 | 40 | 60 |
| | FC (kg/m³) | 210 | 260 | 240 | 220 | 200 |

| | | | | | |
|---|---|---|---|---|---|
| Superplasticizer (kg/m³) | 5.8 | 2.6 | 4.0 | 5.0 | 6.2 |
| 0/4 sand (kg/m³) | 1038 | 1038 | 1038 | 1038 | 1038 |
| W/B | 0.4 | 0.4 | 0.4 | 0.4 | 0.4 |

### Example 3

### Preparation of Concrete Equivalent Mortars According to and not According to the Invention

Concrete equivalent mortars were prepared according to the protocol described in example 1, in the proportions given in table 3. The paste volume corresponds to the percentage of the paste volume relative to the porous volume of the granular skeleton.

The composition of Control G contained no superplasticizer. The composition of Control H had a greater W/B ratio than Test A.

TABLE 3

| | | Test A | Control G | Control H |
|---|---|---|---|---|
| Binder | CEM (kg/m³) | 140 | 140 | 140 |
| | MK (kg/m³) | 50 | 50 | 50 |
| | FC (kg/m³) | 210 | 210 | 210 |

| | | | |
|---|---|---|---|
| Superplasticizer (kg/m³) | 5.8 | 0 | 4 |
| 0/4 sand (kg/m³) | 1038 | 1038 | 975 |
| W/B | 0.4 | 0.4 | 0.5 |
| Paste volume (%) | 126 | 126 | 140 |

### Example 4

### Characterization of the Compositions and Concrete Equivalent Mortars Obtained in Examples 1 to 3

The results of the spread, viscosity and compressive strength (Rc) measurements, performed according to the methods described in the section Materials and Methods, are reported in table 4.

As the tests were carried out on concrete equivalent mortars, the values measured are given by way of comparison. In particular, in light of the strength measurements on prismatic specimens measuring 4×4×16 cm³, the target minimum strength at 28 days to obtain a concrete strength class C25/30 is equal to 30 MPa. Likewise, the achievement of a fluid consistency corresponds to a mortar spread of greater than 250 mm and the maximum viscosity on mortar to obtain a concrete viscosity of less than 9 seconds is 7 seconds.

TABLE 4

| | Spread | Viscosity | Rc_{24 h} | Rc_{28 d} |
|---|---|---|---|---|
| | (mm) | (s) | (MPa) | (MPa) |
| Test A | 350 | 5.6 | 8.2 | 36.3 |
| (35% CEM, 12.5% MK) | | | | |
| Control B (12.5% CEM) | — | 4.4 | 1.9 | 11.4 |
| Control C (0% MK) | — | 4.6 | 7.9 | 23.7 |
| Test D (5% MK) | — | 5.6 | 9.3 | 30.0 |
| Test E (10% MK) | — | 6.4 | 9.1 | 32.0 |
| Test F (15% MK) | — | 6.0 | 7.8 | 40.8 |
| Control G | 100 | not | 9.5 | 28.6 |
| (no superplasticizer) | | measurable | | |
| Control H (W/B = 0.5) | 350 | 2.7 | 4.2 | 18.7 |

As can be seen from table 4, the compressive strength at 24 hours and 28 days is higher for test A compared to control B with a lower cement content, for a substantially similar viscosity.

Furthermore, the compressive strength increases for tests C to F and A when the metakaolin content increases from 0% to 15% in the binder, for a viscosity of less than 7 seconds.

Control G shows that the absence of superplasticizer has a negative impact on compressive strength and on slump compared to Test A, which includes superplasticizer. In addition, viscosity could not be measured for Control G owing to the lack of fluidity of the mortar. As for Control H, compared to Test A, it exhibits a loss of compressive strength when the W/B ratio increases from 0.4 to 0.5.

### Example 5

### Preparation and Characterization of Concretes According to the Invention

Fresh concrete compositions were prepared by mixing 30 L in a forced action laboratory mixer, at an ambient temperature of 20° C., in the proportions indicated in table 5 in kg/m³ for the binder made up of cement (CEM), limestone filler (FC) and an ultrafine particle size material (UF), superplasticizer (SP), aggregates and water. The actual water includes mixing water and water added with the superplasticizer. The paste volume corresponds to the percentage of the paste volume relative to the porous volume of the granular skeleton.

TABLE 5

| | | Test | Test | Test | Test | Test |
|---|---|---|---|---|---|---|
| | | No 1 | No 2 | No 3 | No 4 | No 5 |
| CEM | | 100 | 140 | 140 | 140 | 100 |
| FC | | 250 | 230 | 210 | 210 | 250 |
| UF | Slag | 50 | | | | |
| | Silica fume | | 30 | | | 50 |
| | Metakaolin | | | 50 | | |
| | CEM III | | | | 50 | |

| | | | | | |
|---|---|---|---|---|---|
| Sand | 840 | 840 | 850 | 850 | 840 |
| Fine gravel | 840 | 840 | 850 | 850 | 840 |
| SP (dry extract) | 0.9 | 1.2 | 1.2 | 1.0 | 1.1 |
| Actual water | 155 | 155 | 155 | 154 | 155 |
| Paste volume (%) | 126 | 127 | 125 | 125 | 128 |

The results obtained on fresh concrete are reported in table 6.

TABLE 6

| | Test | Test | Test | Test | Test |
|---|---|---|---|---|---|
| | No 1 | No 2 | No 3 | No 4 | No 5 |
| Slump (mm) | 180 | 210 | 200 | 220 | 220 |
| Consistency class | S4 | S4 | S4 | S4 | S4 |
| Viscosity (s) | 6.5 | 2.9 | 3.0 | 4.2 | 2.0 |

The compressive strength results obtained on the hardened concrete are reported in table 7 and expressed in MPa.

TABLE 7

| | Test No 1 | Test No 2 | Test No 3 | Test No 4 | Test No 5 |
|---|---|---|---|---|---|
| 18 hours | 3.7 | 5.7 | 5.2 | 7.9 | 2.5 |
| 24 hours | 5.9 | | 7.7 | 11.6 | 3.3 |
| 7 days | 24.7 | 26.6 | 28.4 | 31.7 | 15.8 |
| 28 days | 31.1 | 40.4 | 30.5 | 38.3 | 31.3 |

As can be seen from these results, the concretes in tests No 1 to 5 all fall within consistency class S4 and at least strength class C25/30. In addition, they all have a viscosity of less than or equal to 6.5 seconds measured by the inverted cone method according to standard XP P18-469 at a temperature of 20° C.

### LIST OF DOCUMENTS CITED

[1] Antoni et al., Cement and Concrete Research, 2012, 42, 1579-1589;
[2] F. De Larrard, “Structures granulaires et formulation des bétons [Granular structures and formulation of concretes]”, Etudes et Recherches des Laboratoires des Ponts et Chaussées, Ouvrages d'art OA 34, 2000.

1-25. (canceled)

26. A concrete composition comprising:
i) from 350 kg/m³ to 550 kg/m³ of at least one hydraulic binder comprising:
from 20% to 40% of Portland clinkers having a particle dimension D₅₀ of greater than 11 μm and a Blaine specific surface area of less than or equal to 5500 cm²/g,
from 45% to 75% of fillers having a particle dimension D₇₀ of less than or equal to 63 μm, and
from 5% to 15% of an ultrafine particle size material having a BET specific surface area of greater than or equal to 5 m²/g or a D₅₀ of less than or equal to 8 μm, and chosen from hydraulic additives, pozzolanic additives, ultrafine cements, or mixtures of two or more thereof,
ii) at least 0.05% of superplasticizers or plasticizers,
iii) water in a mass ratio of water to binders ranging from 0.3 to 0.45, and
iv) aggregates,
wherein all amounts are by weight, relative to the total weight of the hydraulic binders.

27. The concrete composition of claim 26, comprising Portland clinkers and fillers in a weight ratio of at least 0.32.

28. The concrete composition of claim 26, wherein the total amount of fillers ranges from 45% to 70% by weight, relative to the total weight of the hydraulic binders.

29. The concrete composition of claim 26, wherein the total amount of clinkers ranges from at least 23% by weight, relative to the total weight of the hydraulic binders.

30. The concrete composition of claim 26, wherein the total amount of ultrafine particle size materials ranges from at least 7% by weight, relative to the total weight of the hydraulic binders.

31. The concrete composition of in claim 26, wherein the fillers comprise at least one limestone filler.

32. The concrete composition of claim 26, wherein the ultrafine particle size material is chosen from slag, silica fume, metakaolin, calcined clays, fly ash, natural or artificial pozzolanic additives, ultrafine cements of class CEM I, CEM II, CEM III, CEM IV or CEM V, or mixtures of two or more thereof.

33. The concrete composition of claim 26, wherein the Portland clinkers are in the form of Portland cement.

34. The concrete composition of claim 26, wherein the superplasticizers or plasticizers are chosen from polycarboxylic ethers, polycarboxylic acids, phosphonates, naphthalene-based superplasticizers, polynaphthalene sulfonates, lignosulfonates, or mixtures of two or more thereof.

35. The concrete composition of claim 26, wherein the total amount of superplasticizers or plasticizers ranges from 0.05% to 1% by weight, relative to the total weight of the hydraulic binders.

36. The concrete composition of claim 26, wherein the mass ratio of water to binders ranges from 0.3 to 0.4.

37. The concrete composition of claim 26, wherein the aggregates comprise at least one material having a particle size of between 6 mm and 32 mm.

38. The concrete composition of claim 26, wherein a paste is formed by the mixture of the binder, water, superplasticizer(s) or plasticizer(s) with air and aggregates, wherein the aggregates are sand having a diameter of less than 63 μm, and a volume of the paste is greater than or equal to 115% of a porous volume of a granular skeleton formed by the aggregates.

39. The concrete composition of claim 26, wherein the concrete composition has a viscosity of less than or equal to 9 seconds at a temperature of 20° C. after mixing components (i) to (iv).

40. The concrete composition of claim 26, wherein the concrete composition has an Abrams cone slump of greater than or equal to 160 mm at a temperature of 20° C. after mixing components (i) to (iv).

41. A method for preparing a concrete composition, the method comprising preparing a mixture by mixing:
i) from 350 kg/m³ to 550 kg/m³ of at least one hydraulic binder comprising:
from 20% to 40% of Portland clinkers having a particle dimension D₅₀ of greater than 11 μm and a Blaine specific surface area of less than or equal to 5500 cm²/g,
from 45% to 75% of fillers having a particle dimension D₇₀ of less than or equal to 63 μm, and
from 5% to 15% of an ultrafine particle size material having a BET specific surface area of greater than or equal to 5 m²/g or a D₅₀ of less than or equal to 8 μm, and chosen from hydraulic additives, pozzolanic additives, ultrafine cements, or mixtures of two or more thereof,
ii) at least 0.05% of superplasticizers or plasticizers,
iii) water in a mass ratio of water to binders ranging from 0.3 to 0.45, and
iv) aggregates,
wherein the concrete composition has an Abrams cone slump of greater than or equal to 160 mm at a temperature of 20° C. after mixing components (i) to
(iv) and a viscosity of less than or equal to 9 seconds at a temperature of 20°° C. after mixing,
wherein all amounts are by weight, relative to the total weight of the hydraulic binders, and
wherein the weight ratio of Portland clinkers to fillers ranges from at least 0.32.

42. The method according to claim 41, further comprising leaving the mixture still for 28 days after mixing components (i) to (iv).

43. The method according to claim 41, further comprising disposing the concrete composition on a structural element to prepare a hardened concrete composition.

44. The method according to claim 43, wherein the hardened concrete has a compressive strength of greater than or equal to 25 MPa.

45. The method according to claim 43, wherein the structural element comprises at least one of a pile, a diaphragm wall, a footing, a stringer, a slab, a floor, a post, a beam, or a veil.
